(19) United States
(12) Patent Application Publication
(10) Pub. No.: US 2026/0104567 A1
(43) Pub. Date: Apr. 16, 2026

(54) OPTICAL FIBER CABLE INSTALLATION HAVING AN OPTICAL FIBER CABLE AND GASKET DISPOSED IN A TRENCH

(71) Applicant: CORNING RESEARCH & DEVELOPMENT CORPORATION, Corning, NY (US)

(72) Inventors: Brian Matthew Cole, Austin, TX (US); David Montalion Dupuis, Cedar Park, TX (US); Cary Alan Kipke, Pflugerville, TX (US); Donald Kent Larson, Cedar Park, TX (US); Raman Kumar Selli, Austin, TX (US)

(21) Appl. No.: 19/421,034

(22) Filed: Dec. 16, 2025

Related U.S. Application Data
(63) Continuation of application No. PCT/US2024/035963, filed on Jun. 28, 2024.
(60) Provisional application No. 63/523,986, filed on Jun. 29, 2023.

(51) Int. Cl. G02B 6/50; G02B 6/44

(52) U.S. Cl. CPC G02B 6/504; G02B 6/443

(57) ABSTRACT

Embodiments of the disclosure relate to an installation. The installation includes pavement having a top surface and a trench formed in the pavement. The trench has a first region having a first width, and a second region having a second width that is less than the first width. The first region is closer to the top surface than the second region. An optical fiber cable is disposed in the second region of the trench. A gasket is disposed in the first region of the trench and covers the optical fiber cable. Further, the first region of the trench has first sidewalls and a first floor, and the gasket is disposed between the first sidewalls and abutted against the first floor.

### CROSS-REFERENCE TO RELATED APPLICATION

This application is a continuation of Internation Patent Application No. PCT/US2024/035963, filed on Jun. 28, 2024, which claims the benefit of priority of U.S. Provisional Application No. 63/523,986, filed on Jun. 29, 2023, the content of which is relied upon and incorporated herein by reference in its entirety.

### BACKGROUND

The disclosure relates generally to an optical fiber cable installation and more particularly to an installation in which the optical fiber cable is disposed in a trench and secured with a gasket.

Optical fiber cables are deployed in a variety of different installations. For example, aerial cables may be strung across utility poles, and underground optical fiber cables may be carried in ducts. For running an optical fiber cable to a subscriber or to 5G antennas, a low fiber count cable may be utilized, and one way to provide the cable is to run the cable along or across a roadway in a trench. However, running an optical fiber cable over a roadway requires shutting down of traffic, and thus, quick and secure methods of installation are desirable. Further, the installation must be able to account for temperature fluctuations that can lead to cable bending or buckling, which can cause signal attenuation.

### SUMMARY

According to an aspect, embodiments of the disclosure relate to an installation. The installation includes pavement having a top surface and a trench formed in the pavement. The trench has a first region having a first width, and a second region having a second width that is less than the first width. The first region is closer to the top surface than the second region. An optical fiber cable is disposed in the second region of the trench. A gasket is disposed in the first region of the trench and covers the optical fiber cable. Further, the first region of the trench has first sidewalls and a first floor, and the gasket is disposed between the first sidewalls and abutted against the first floor.

According to another aspect, embodiments of the disclosure relate to a gasket for carrying at least one optical fiber cable within a trench. The gasket includes an elongated elastomeric body having a longitudinal axis along a length thereof. At least one cavity is formed in the elastomeric body and extends longitudinally along the length of the elastomeric body. Each of the at least one cavity has a first dimension perpendicular to the longitudinal axis and a second dimension perpendicular to the longitudinal axis and to the first dimension. The first dimension is greater than the second dimension.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts an installation of an optical fiber cable in a trench having a rectangular gasket, according to an exemplary embodiment;

FIG. 2 depicts an installation of an optical fiber cable in a trench having a T-shaped gasket, according to an exemplary embodiment;

FIG. 3 depicts an installation of an optical fiber cable in a trench having a gasket with angled surfaces to engage a trench with angled sidewalls, according to an exemplary embodiment;

FIG. 4 depicts an installation of an optical fiber cable in a trench having a gasket with ribs designed to engage sidewalls of the trench, according to an exemplary embodiment;

FIG. 5 depicts an installation of an optical fiber cable within a gasket that is inserted in a trench, according to an exemplary embodiment;

FIG. 6 depicts a gasket having an interior conduit to enhance cable blowing, jetting, or pulling, according to an exemplary embodiment;

FIG. 7 depicts a gasket having a plurality of cavities containing a plurality of conduits for carrying optical fiber cables, according to an exemplary embodiment;

FIG. 8 depicts a multipiece gasket, according to an exemplary embodiment;

FIG. 9 depicts another multipiece gasket, according to an exemplary embodiment;

FIG. 10 depicts a pre-connectorized optical fiber cable disposed in a gasket, such as a gasket according to FIG. 8 or 9, according to an exemplary embodiment;

FIGS. 11-13 depict foldable gaskets having a hinge joining two halves of the gasket, according to an exemplary embodiment;

FIGS. 14-16 depict foldable gaskets having a thinned region joining two halves of the gasket, according to an exemplary embodiment;

FIG. 17 depicts a foldable gasket having a plurality of cavities containing a plurality of conduits, according to an exemplary embodiment;

FIGS. 18A-18D depict a gasket having wings configured to engage trenches with either straight or angled sidewalls, according to an exemplary embodiment; and

FIG. 19 depicts an installation of an optical fiber cable within a flexible tube that is inserted in a trench, according to an exemplary embodiment.

### DETAILED DESCRIPTION

Referring generally to the figures, various embodiments of a gasket for optical fiber cable installations formed in roadway trenches are provided. In certain circumstances, optical fiber cables may be laid in shallow trenches formed along a roadway to provide quick connections to subscribers or network equipment. Various methods have been used to fill the trenches to secure the cables within, but many of the methods have drawbacks, such as long down times while backfill material cures or deterioration of the filling/covering material. According to embodiments of the present disclosure, optical fiber cables in roadway trenches are secured using elastomeric gaskets. In certain embodiments, the elastomeric gasket covers the optical fiber cable within the trench, and in certain other embodiments, the optical fiber cable is carried within the elastomeric gasket. The elastomeric gaskets can be configured for a variety of contexts, such as carrying multiple optical fiber cables within separate cavities and folding substantially flat for winding on a spool for storage, transport, and installation. Advantageously, the elastomeric gaskets are relatively quick to install, do not require cure time, and do not deteriorate under typical traffic conditions. Exemplary embodiments of such gaskets will be described in greater detail below and in relation to the figures provided herewith, and these exemplary embodiments are provided by way of illustration, and not by way of limitation.

The figures and following disclosure set forth examples of different gasket configurations adapted for use in a various roadway installations. Each of the embodiments described herein is based on a gasket having an elastomeric body. In one or more embodiments, the gasket has a body comprised of an elastomer selected from the group consisting of polyurethane, silicone, a synthetic rubber, and combinations thereof. Examples of synthetic rubbers suitable for use according to embodiments of the present disclosure include neoprene, nitrile, butyl, ethylene propylene diene monomer (EPDM), and blends thereof. As will be discussed more fully below, the gasket may consist entirely of the elastomeric material, or the gasket may include other coatings or structures (such as conduit). Additionally, the gasket may frictionally engage the trench, or an adhesive may be used to enhance engagement between the gasket and the trench.

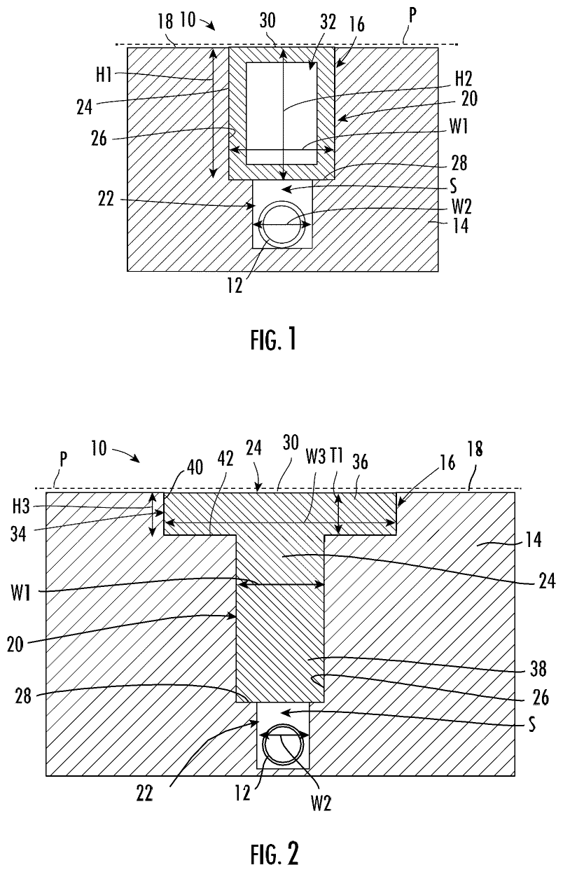

FIGS. 1-4 depict various embodiments of gaskets configured to cover an optical fiber cable in a trench. In the embodiments described below, the optical fiber cable is positioned below the gasket, providing sufficient spacing for the optical fiber cable to bend sinusoidally along its length in response to thermal expansion.

FIG. 1 depicts an embodiment of an installation 10 of an optical fiber cable 12 disposed in pavement 14. The pavement 14 may be any of a variety of pavement types, including for example concrete and asphalt. In one or more embodiments, the installation 10 includes a trench 16 formed in the pavement 14. The pavement 14 has a top surface 18 defining a plane P of the pavement 14, and the trench 16 is recessed from the plane P defined by the top surface 18. While the plane P is depicted as being positioned above the top surface 18 for the purposes of improved visibility, it is to be understood that the plane P is intended to be a plane coincident with the top surface 18 of the pavement 14. In one or more embodiments, the trench 16 includes a plurality of steps. In the embodiment depicted in FIG. 1, the trench 16 includes two steps defining a first region 20 and a second region 22. The first region 20 has a first width W1, and the first region 20 is positioned relatively closer to the plane P of the top surface 18 than the second region 22. The second region 22 has a second width W2, and the second region 22 is positioned relatively farther from the plane P of the top surface 18 than the second region 22. The second width W2 is less than the first width W1.

In one or more such embodiments, the optical fiber cable 12 is positioned within the second region 22 of the trench 16. In such embodiments, the second width W2 of the second region 22 of the trench 16 may be selected to be slightly wider than the width of the optical fiber cable 12. In one or more embodiments, the second width W2 of the second region 22 is 25% to 50% larger than the width of the optical fiber cable 12 to allow the optical fiber cable 12 to move freely for relief of axial strains. In one or more embodiments, the second width W2 is up to 0.5 inches. The optical fiber cable 12 can be any of a variety of types of optical fiber cables 12, depending on the requirements of the installation 10. For example, to provide access to a subscriber, the optical fiber cable 12 may include only a single optical fiber and have cross-sectional dimensions of 3 mm×6.6 mm (e.g., ROC™ drop cable, available from Corning Incorporated, Corning, NY). In other installations 10, the optical fiber cable 12 may contain up to 72 optical fibers and have a diameter of up to 4.5 mm (e.g., MiniXtend® HD cable, available from Corning Incorporated, Corning, NY). In addition, a microduct may be installed in the second region 22 of the trench 16, and the optical fiber cable 12 may pulled or blown into the microduct (e.g., 10 mm OD×8 mm ID MicroDuct, available from Dura-Line Corporation, Knoxville, Tennessee).

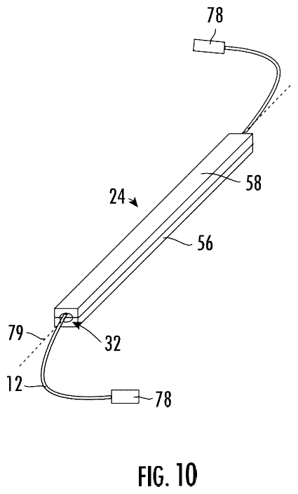

During installation, the optical fiber cable 12 is laid in the second region 22 of the trench 16, and a gasket 24 is inserted into the first region 20 of the trench 16 over the optical fiber cable 12. In particular, the first region 20 of the trench 16 has sidewalls 26 and a floor 28. The second region 22 of the trench 16 is formed through the floor 28, and the gasket 24 is positioned within the first region 20 of the trench 16. In one or more embodiments, the gasket 24 frictionally engages the sidewalls 26 and/or the floor 28 to cover the second region 22 and thus optical fiber cable 12. In one or more other embodiments, an adhesive may be applied at least partially around the gasket 24 to adhere the gasket 24 to the sidewalls 26 and/or the floor 28 of the first region 20. In such embodiments, the gasket 24 may include grooves formed in its outer surface to hold the adhesive for engagement with the sidewalls 26 and/or the floor 28. Examples of such grooves are shown and will be discussed more fully below in relation to FIG. 9. The discussion of the frictional engagement and the adhesive engagement, including with grooves, is applicable to any of the embodiments of the gasket described herein.

As can be seen in the embodiment of FIG. 1, the gasket 24 has a rectangular cross-section that substantially fills the first region 20. The sidewalls 26 of the first region 20 have a first height H1, and the gasket 24 has a second height H2. In one or more embodiments, the second height H2 is equal to or less than the first height H1 such that the gasket 24 has an upper surface 30 at or below the plane P of the top surface 18 of the pavement 14. In one or more embodiments, the second height H2 is up to 6 mm less than the first height H1 such that the upper surface 30 is up to 6 mm below the plane P of the top surface 18 of the pavement 14. In such embodiments, recessing the gasket 24 protects the gasket from wear related to tire contact while also maintaining a desired aesthetic appearance and smoothness for bike riders and pedestrians.

In one or more embodiments, the upper surface 30 of the gasket is treated, coated, or textured to reduce headlight glare and blend with the roadway pavement. In one or more embodiments, the upper surface 30 is provided with a matte finish. While discussed in relation to the embodiment of FIG. 1, such treatment, coating, or texture (e.g., matte finish) of the upper surface 30 applies as well to any of the subsequently discussed gasket embodiments.

In one or more embodiments, including the embodiment of FIG. 1, the gasket 24 includes a central cavity 32. The central cavity 32 extends longitudinally along the length of the gasket 24. The central cavity 32 reduces the amount of material necessary to form the gasket 24 and enhances the compliance of the gasket 24 for fitting into the trench 16. Additionally, the cavity 32 allows the gasket 24 to better absorb puncture loads.

Advantageously, the gasket 24 provides a cover to retain and protect the optical fiber cable 12 in the second region 22 of the trench 16 while also allowing space above optical fiber cable 12 to allow for sinusoidal bending of the optical fiber cable 12 in response to thermal expansion. In one or more embodiments, the gasket 24 and trench 16 are designed to provide a space S above the optical fiber cable 12 having a height of greater than or equal to 0.5× the diameter of the optical fiber cable 12 and less than or equal to 2× the diameter of the optical fiber cable 12. For example, for an optical fiber cable 12 having an outer diameter of 4.5 mm, the space S may be in a range from 2.2 mm to 9 mm. In this regard, the stepped shape of the trench 16 provides an abutment surface (floor 28 of first region 20) to position the gasket 16 and ensure that it will not be driven down into the second region 22 where the optical fiber cable 12 resides.

FIG. 2 depicts another embodiment of an installation 10 in which the gasket 24 is T-shaped and in which the stepped trench 16 includes a third region 34. The third region 34 is positioned above the first region 20 such that the first region 20 is disposed between the third region 34 and second region 22. As can be seen, the third region 34 has a third width W3 that is greater than the first width W1 of the first region 20, which is greater than the second width W2 of the second region 22. In this way, the trench 16 defines three steps. The T-shaped gasket 24 has a cross member 36 and a post 38 extending from approximately the midpoint of the cross member 36.

As can be seen in FIG. 2, the cross member 36 is situated in the third region 34, and the post 38 is situated in the first region 20. In one or more embodiments, the bottom of the post 38 abuts the floor 28, and the sides of the post 38 frictionally and/or adhesively engage the sidewalls 26. The third region 34 defines second sidewalls 40 and a second floor 42. The bottom of the cross member 36 abuts the second floor 42 and may be adhered to the second floor 42. In one or more embodiments, the edges of the cross member 36 frictionally and/or adhesively engage the second sidewalls 40, but in one or more other embodiments, a clearance is provided between the edges of the cross member 36 and the second sidewalls 40 to facilitate positioning of the gasket 24 within the trench 16.

The cross member 36 has a first thickness T1, and the second sidewalls 40 have a third height H3. In one or more embodiments, the first thickness T1 of the cross member 36 is equal to or less than the third height H3 of the second sidewalls. In this way, the upper surface 30 defined by the cross member 36 sits at or below the plane P defined by the top surface 18 of the pavement 14. As with the previous embodiment, the upper surface 30 may sit up to 6 mm below the plane P defined by the top surface 18 of the pavement 14.

Also, similar to the previous embodiment, the optical fiber cable 12 resides in the second region 20, and the spacing S may be provided between a bottom of the post 38 and the optical fiber cable 12 to allow for sinusoidal bending of the optical fiber cable 12 resulting from thermal expansion. Advantageously, the T-shaped gasket 24 further resists impingement against the optical fiber cable 12 because of the additional abutment surface in the form of the second floor 42. That is, as vehicles pass over gasket 24, the gasket 24 will experience repeated tire hits that exert downward pressure on the gasket 24, and contact between the cross member 26 and the second floor 42 provides additional resistance against the post 38 pressing into the second region 22.

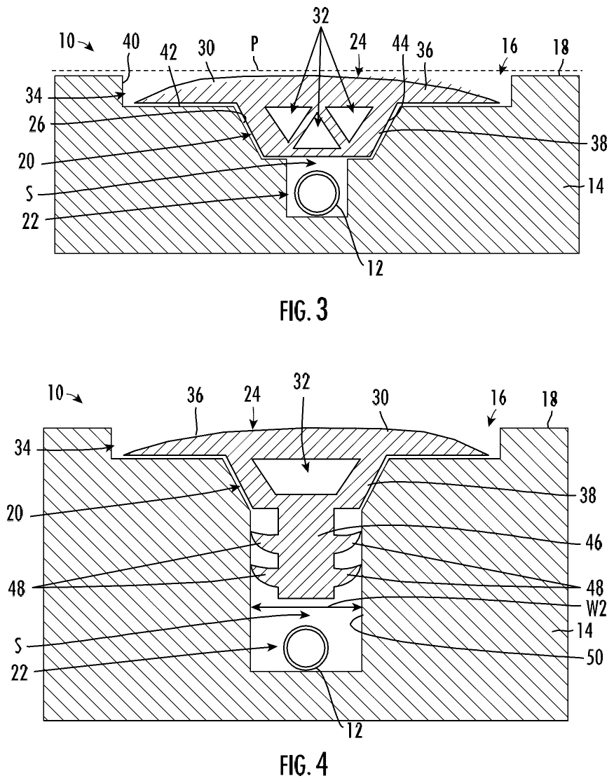

FIG. 3 depicts another embodiment of an installation 10 in which the trench 16 has three regions 20, 22, 34, and the first region 20 has angled sidewalls 26. The gasket 24 includes a cross member 36 and a post 38 extending from the cross member 36. In one or more embodiments, including the embodiment depicted in FIG. 3, the cross member 36 defines a domed upper surface 30. Further, in one or more embodiments, including the embodiment depicted in FIG. 3, the post has angled surfaces 44 that substantially match the angled sidewalls 26 of the first region 20.

In one or more embodiments, the post 38 includes one or more cavities 32 formed longitudinally along the length of the gasket 24. In this way, the post 38 of the gasket 24 is more compliant and can be compressed between the angled sidewalls 26 of the first region 20. The cavities 32 also reduce the amount of material required to form the gasket 24 and help absorb puncture loads.

As with the prior embodiments, the gasket 24 covers the second region 22 in which the optical fiber cable 12 resides, and a spacing S may be provided between the optical fiber cable 12 and the bottom of the gasket 24 (i.e., bottom of post 38). Further, in the embodiment depicted, the domed upper surface 30 of the gasket 24 may have a maximum height that sits at or below the plane P defined by the top surface 18 of the pavement 14. Also like the previous embodiment, the trench 16 defines three steps that provides two abutment surfaces (floor 28 and second floor 42) that prevent the gasket 24 from impinging upon the optical fiber cable 12 when exposed to repeated tire hits.

Regarding the shape of the trench 16, Applicant has found that it can be difficult to grind straight sidewalls 26 in certain types of pavement 14 and that forming angled sidewalls 26 can produce a better finish, improving contact with the gasket 24. Thus, in the first region 20 where the gasket 24 forms the tight frictional engagement with the trench 16, the sidewalls 26 of the first region 20 may be angled, and the gasket 24 may be shaped to match the angled sidewalls 26. In one or more embodiments, the angled sidewalls 26 form an angle of up to 45°, in particular up to 30°, relative to vertical.

FIG. 4 depicts an embodiment similar to that depicted in FIG. 3, but the embodiment of FIG. 4 extends into the second region 22. In particular, the gasket 24 includes a second post 46 extending from the post 38. In the trench 16, the second post 46 is disposed in the second region 22 with the optical fiber cable 12. In one or more embodiments, the second region 22 of the trench 16 is formed to a greater depth than, e.g., the embodiments shown in FIGS. 1-3 in which the gasket 24 does not extend into the second region 22 to provide adequate spacing S between the bottom of the gasket 24 and the optical fiber cable 12.

In one or more embodiments, the second post 46 includes a plurality of compliant ribs 48 extending from the sides of the second post 46. The distance between ends of the ribs 48 on opposite sides of the second post 46 is greater than the second width W2 of the second region 22. In this way, when the gasket 24 is forced into the trench 16, the ribs 48 bend upwardly as the gasket 24 moves downwardly such that the ribs 48 engage third sidewalls 50 of the second region 22. As such, the gasket 24 of FIG. 4 provides additional frictional engagement with the trench 16 while also providing the two abutment surfaces (floor 28 and second floor 42) to prevent the gasket 24 from impinging upon the optical fiber cable 12.

In one or more embodiments, including the embodiment shown in FIG. 4, the gasket 24 includes a cavity 32 within the post 38 that extends longitudinally along the length of the gasket 24. As in the previous embodiments, the cavity 32 allows the gasket 32 to be compressed within the trench 16, reduces the amount of material required to form the gasket 24, and helps absorb puncture loads on the gasket 24.

FIGS. 5-7 depict various embodiments of gaskets configured to hold an optical fiber cable within a trench. In the embodiments described below, the optical fiber cable is positioned inside a cavity of the gasket. In such embodiments, the cavity provides sufficient spacing for the optical fiber cable to bend sinusoidally along its length in response to thermal expansion.

FIG. 5 depicts an embodiment of a gasket 24 in a trench 16 in which the optical fiber cable 12 is positioned within a cavity 32 of the gasket 24. In one or more embodiments, the trench 16 is not stepped and has just the first region 20 with one floor 28 and two sidewalls 26. In this way, the trench 16 is substantially rectangular, and the gasket 24 is substantially rectangular to fill the trench 16.

As shown in the embodiment of FIG. 5, the second height H2 of the gasket 24 is equal to or less than the first height H1 of the sidewalls 26. In this way, the gasket 24 is even with or below (e.g., up to 6 mm below) the plane P defined by the top surface 18 of the pavement 14.

In order to position the optical fiber cable 12 within the cavity 32 of the gasket 24, the gasket 24 includes a split 52 at one end of the cavity 32. In this way, the gasket 24 can be opened by pulling the top end of the gasket 24 apart, the optical fiber cable 12 can be inserted, and then the gasket 24 can be closed around the optical fiber cable 12. After providing the optical fiber cable 12 in the gasket 24, the gasket 24 is then pressed into the trench 16.

Alternatively, in one or more embodiments, a conduit can be inserted into the cavity 32 of the gasket 24, and then the gasket 24 containing the conduit is pressed into the trench 16. In this way, an optical fiber cable 12 can be jetted, blown, or pulled through the conduit to position the optical fiber cable 12 within the trench 16. Advantageously, the conduit may provide a lower coefficient of friction than the gasket 24 with respect to the jacket material of the optical fiber cable 12. For example, a coefficient of friction between a gasket 24 made of elastomeric material and a cable jacket of polyethylene may be as high as 0.65, making blowing, jetting, or pulling the optical fiber cable 12 through the cavity 32 of the gasket 24 difficult. By using a conduit having a lower coefficient of friction with the jacket material, such as 0.2 or less, the optical fiber cable 12 can be blown, jetted, or pulled through the cavity 32 of the gasket 24 after the gasket 24 is pressed into the trench 16. In still one or more other embodiments, the cavity 32 can be coated with a friction-reducing material (such as polyethylene or polytetrafluoroethylene) to allow for blowing, jetting, or pulling of an optical fiber cable 12 within the cavity 32.

To provide sufficient space for the optical fiber cable 32 to bend sinusoidally along its length, the cavity 32 in one or more embodiments is an elongated shape, such as a racetrack, rectangle, oval, or ellipse. In particular, the cavity 32 has a first dimension D1 perpendicular to the longitudinal axis and a second dimension D2 perpendicular to both the longitudinal axis and to the first dimension D1. To provide the elongated shape, the first dimension D1 is greater than the second dimension D2.

By providing the optical fiber cable 12 within a cavity 32 of the gasket 24, repairs to the cable and gasket 24 may be made more simply. In particular, the optical fiber cable 12 can be removed without removing the gasket 24 from the trench 16. For example, if the optical fiber cable 12 is damaged along its length, the optical fiber cable 12 can be pulled from the gasket 24 without requiring the entire gasket 24 to be removed from the trench 16. Further, if the gasket 24 is damaged, a section of gasket 24 can be removed and replaced and the optical fiber cable 12 re-installed in the gasket 24.

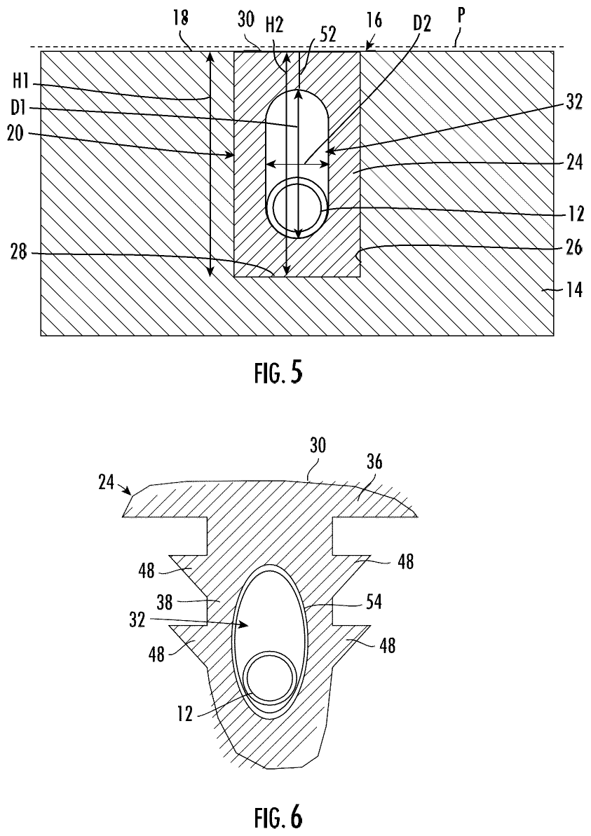

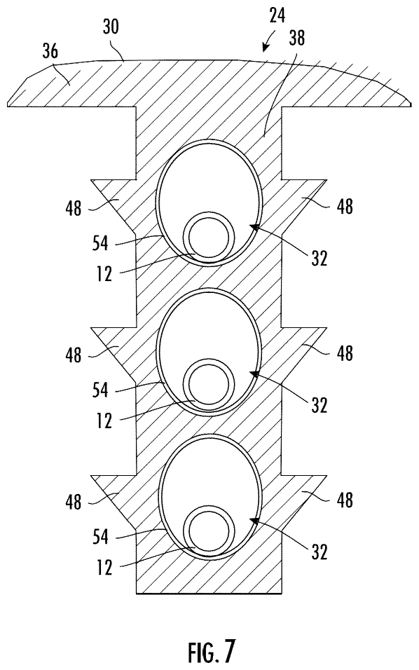

FIG. 6 depicts another embodiment of a gasket 24 in which the gasket 24 includes an interior conduit 54. As discussed in the previous embodiment, the conduit 54 may be used to reduce the frictional forces on the optical fiber cable 12 when blowing, jetting, or pulling the optical fiber cable 12 through the gasket 24. As shown in FIG. 6, the gasket 24 is generally T-shaped and includes a cross member 36 having a domed upper surface 30 and a post 38. A cavity 32 is formed in the post 38, and the conduit 54 is contained in the cavity 32. Further, in one or more embodiments, the post 38 includes ribs 48 to enhance frictional engagement with the trench. In one or more embodiments, the conduit 54 has a ribbed inner surface that further reduces friction, allowing for longer pulls through the conduit 54. An example of a commercially available conduit 54 with a ribbed inner surface suitable for use according to embodiments of the present disclosure is the smooth-out/ribbed-in conduit from Dura-Line (Knoxville, TN). In one or more embodiments, the conduit 54 is selected such that the optical fiber cable 12 fills from 50% to 80% of the interior cross-sectional area of the conduit 54.

FIG. 7 depicts an embodiment of a gasket 24 having multiple interior conduits 54. The gasket 24 of FIG. 7 is substantially similar to the gasket 24 of FIG. 6 except that the gasket 24 of FIG. 7 includes a post 38 having a length sufficient to carry multiple conduits 54 for multiple optical fiber cables 12. In the embodiment depicted in FIG. 7, the gasket 24 includes three cavities 32 to carry three conduits 54. In the embodiment depicted, the three cavities 32 are arranged in a column, but the gasket 24 may include more than three cavities arranged in single column, a single row, or a combination of rows and columns (e.g., 2 columns with 3 rows). In this way, a plurality of cavities 32 can be provided in the post 38 without requiring a deep trench 16 to be cut.

A gasket 24 with multiple conduits 54 allows for the orderly arrangement of multiple optical fiber cables 12 within a trench and isolates the optical fiber cables 12 from crossover point loads and tangling. Further, such a gasket 24 allows for optical fiber cables 12 to be installed at different times. For example, the gasket 24 with a first an optical fiber cable 12 can be installed in a trench initially, and at a later time, a second and/or third optical fiber cable 12 can be blown, jetted, or pulled through the remaining conduits 54.

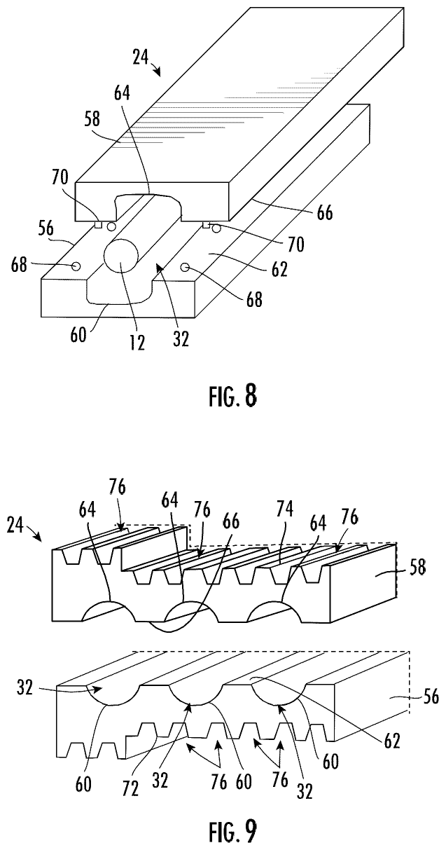

FIGS. 8 and 9 depict embodiments of multipiece gaskets configured to be assembled around an optical fiber cable and then pressed into a trench. In such embodiments, each piece of the gasket defines a portion of the cavity that surrounds the optical fiber cable, and the pieces are mated together to define the gasket.

FIG. 8 depicts a gasket 24 including a first piece 56 and a second piece 58. The first piece 56 includes a first channel 60 formed in a first inward surface 62, and the second piece 58 includes a second channel 64 formed in a second inward surface 66. The first piece 56 and the second piece 58 are provided on opposite sides of the optical fiber cable 12 and joined together. In this way, the first channel 60 and the second channel 64 together define the cavity 32 that carries the optical fiber cable 12. In one or more embodiments, the first inward surface 62 mates with the second inward surface 66. As shown in the embodiment of FIG. 8, the first inward surface 62 includes a plurality of holes 68 configured to receive a plurality of pegs 70; however, in other embodiments, the mating features may be different, such as hook-and-loop fastener and snap-lock features, amongst other possibilities.

Further, in one or more embodiments, either or both of the inward surfaces 62, 66 includes an adhesive to join the pieces 56, 58. In one or more embodiments, the first piece 56 is inserted into the trench and acts as a bed for the optical fiber cable 12, and the second piece 58 is pressed into the trench over the optical fiber cable 12 to complete the gasket 24. In one or more such embodiments, the first piece 56 is adhered to the floor of the trench to secure it in place. Alternatively, the pieces 56, 58 of the gasket 24 can be assembled around the optical fiber cable 12 first, and the completed gasket 24 carrying the optical fiber cable 12 can then be inserted into the trench.

FIG. 9 depicts a multipiece gasket 24 having a first piece 56 and a second piece 58 that define a plurality of cavities 32. The first piece 56 includes a first inward surface 62 defining a plurality of first channels 60, and the second piece 58 includes a second inward surface 66 defining a plurality of second channels 64. When the first piece 56 is joined to the second piece 58, the plurality of first channels 60 and the plurality of second channels 64 together define the plurality of cavities 32. During assembly, each of the cavities 32 can be filled with an optical fiber cable 12. Alternatively, for example, only one cavity 32 may include an optical fiber cable 12 during assembly and installation, and optical fiber cables 12 can be jetted, blown, or pulled into the remaining cavities 32 after the gasket 24 is installed in the trench. As with the previous embodiment, the inward surfaces 62, 66 may be mated together or joined using adhesives.

The first piece 56 of the gasket 24 includes a first outer surface 72, and the second piece 58 includes a second outer surface 74. In one or more embodiments, the first outer surface 72 and the second outer surface 74 include a plurality of grooves 76 configured to receive adhesive. When the gasket 24 is inserted into the trench, the adhesive helps ensure a strong engagement with the sidewalls of the trench. Further, as shown in FIG. 9, the outer surface 72, 74 of the pieces 56, 58 are configured to engage a stepped trench profile.

FIG. 10 depicts an embodiment of a gasket 24, such as the gaskets 24 shown in FIG. 8 or 9, formed around a pre-connectorized optical fiber cable 12. That is, the optical fiber cable 12 is factory-terminated with optical connectors 78. Further, in the factory setting, the pieces 56, 58 of the gasket 24 can be assembled to form the cavity 32 extending along the longitudinal axis 79 of the gasket 24 around the optical fiber cable 12, and the assembly of the gasket 24 and pre-connectorized optical fiber cable 12 can be taken up on a spool in various lengths for transport to and installation in the field. Advantageously, the pieces 56, 58 can be peeled apart and easily trimmed to the length of the trench in the field.

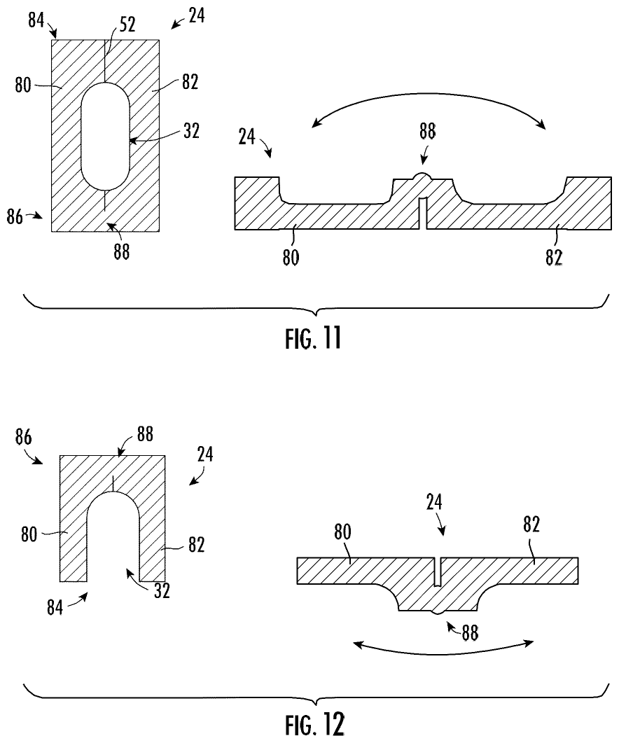

FIGS. 11-17 depict embodiments of a foldable gasket having two halves joined by a hinge of elastomeric material. The gasket is folded around an optical fiber cable to form the cavity in which the optical fiber cable resides. Advantageously, the foldable gasket allows for the gasket to be more easily stored on a spool because, in the unfolded position, the gasket lies flatter than gaskets that do not fold.

FIG. 11 depicts an embodiment of a foldable gasket 24. The foldable gasket 24 includes a first half 80 and a second half 82. On a first end 84 of the gasket 24, the first half 80 and the second half 82 are separated by a split 52. On a second end 86 of the gasket 24, the first half 80 and the second half 82 are joined by a hinge 88. As can be seen in FIG. 11, the first half 80 and the second half 82 can be reversibly folded at the hinge 88 to open and close the gasket 24. In this regard, the gasket 24, in one or more embodiments, is in an unstressed state in the folded configuration, and unfolding the gasket 24 requires the gasket 24 to elastically deform at the hinge 88. This elastic deformation in the unfolded configuration biases the gasket 24 back to the folded position. When closed, the halves 80, 82 define the cavity 32 in which the optical fiber cable is positioned. When opened, the halves 80, 82 are able to lie substantially flat such that the gasket 24 can more easily be wound and stored on a spool for ease of storage, transport, and installation. As shown in FIG. 11, the hinge 88 is a thin section of the elastomeric material of the gasket 24 that allows the halves 80, 82 to bend apart from each other while keeping the halves 80, 82 connected.

FIG. 12 depicts another embodiment of a foldable gasket 24 in which the first half 80 and the second half 82 define an open cavity 32 at the first end 84 of the gasket. At the second end 84, the first half 84 and the second half 86 are joined by the hinge 88, and with the open first end 84, the gasket 24 defines an inverted U-shape. In such embodiments, the gasket 24 is installed in the trench with the first end 84 arranged toward the floor of the trench. In one or more embodiments, the gasket 24 can be sized for use with a stepped trench or with a rectangular trench.

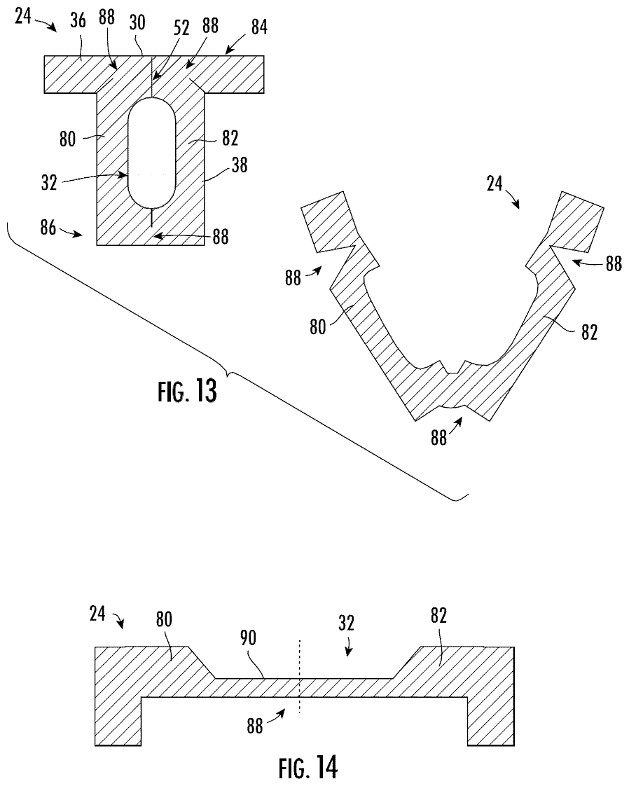

FIG. 13 depicts another embodiment of a foldable gasket 24. In the embodiment, the halves 80, 82 of the gasket 24 define a cross member 36 and a post 38. To fold flat, the halves 80, 82 of the gasket 24 are separated by a split 52 at the first end 84 and are joined by a hinge 88 at the second end 86 of the gasket 24. To allow the cross member 36 to fold flat, additional hinges 88 are provided at the corners between the cross member 36 and the post 38. In one or more embodiments, the hinges 88 at the corners extend diagonally from the corners toward the upper surface 30.

FIG. 14 depicts another embodiment of a foldable gasket 24 in the unfolded configuration. In contrast to the previous hinged embodiments, the unfolded configuration of this embodiment is the unstressed state. As can be seen, the first half 80 and the second half 82 include a thinned region 90 therebetween that is configured to wrap around an optical fiber cable when the gasket 24 is folded. In this way, the thinned region 90 operates as the hinge 88 while also defining the cavity 32 for the optical fiber cable. FIG. 15 depicts the gasket 24 of FIG. 14 installed in a trench 16. As can be seen, the trench 16 is stepped with a first region 20 and a second region 22. The gasket 24 defines a cross member 36 that is positioned within the first region 20, and the thinned section 90 that defines the hinge 88 and cavity 32 is positioned within the second region 22 around the optical fiber cable 12.

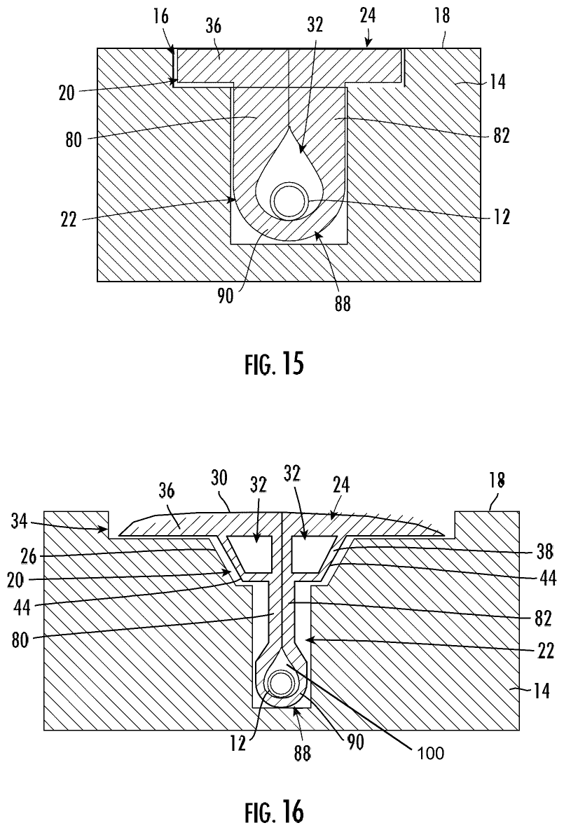

FIG. 16 depicts another embodiment of a foldable gasket 24 that is similar to the embodiment shown in FIGS. 14 and 15. In particular, the gasket 24 of FIG. 16 includes a thinned region 90 disposed between the first half 80 and the second half 82 of the gasket 24 that is configured to provide the folding hinge 88 of the gasket 24 and define a cavity 100 in which the optical fiber cable 12 resides. In the embodiment of FIG. 16, the gasket 24 is configured to be used with a three stepped trench 16 having a first region 20, a second region 22, and a third region 34. The halves 80, 82 of the gasket 24 depicted in FIG. 16, when joined by folding the gasket 24 at the folding hinge 88, define a cross member 36 having a domed upper surface 30 that is disposed in the third region 34 of the trench 16. The first region 20 of the trench 16 has angled sidewalls 26, and the halves 80, 82 of the gasket 24 defined angled surfaces 44 of the post 38 configured to engage the angled sidewalls 26 of the first region 20. As with the previous embodiment, the thinned region 90 defining the cavity 100 around the optical fiber cable 12 is disposed in the second region 22 of the trench 16. As shown in FIG. 16, the post 38 disposed in the second region 20 also includes additional cavities 32 that extend longitudinally along the length of the gasket 24 to provide compliance and reduce the amount of material needed to form the gasket 24.

Besides the ability to wind the foldable gaskets 24 on a spool, the foldable gaskets 24 also allow for a coating to be applied to the cavity 100 more easily. In the unfolded configuration, the halves of the cavity 100 or interior of the thinned region 90 are exposed, and a low friction coating can be applied to the cavity/thinned region surface, e.g., by extrusion, spraying, or other deposition techniques. Examples of low friction coatings include polyethylene or polytetrafluoroethylene. Thereafter, when the gasket 24 is folded around the optical fiber cable 12, the surface of the cavity 100 will have a low coefficient of friction (e.g., ≤0.20) with respect to the optical fiber cable 12 for blowing, jetting, or pulling.

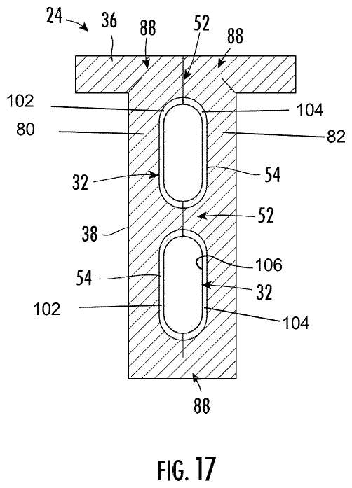

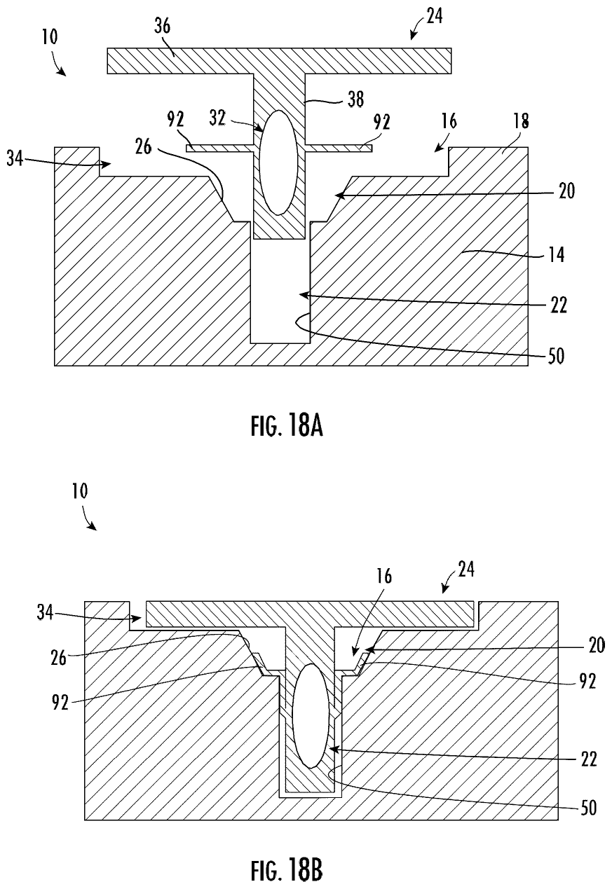

FIG. 17 depicts a foldable gasket 24 having a plurality of cavities 32 containing a plurality of conduits 54. Each of the plurality of conduits can be formed from a respective first half 102 and second half 104. In one or more embodiments, the first half 80 and the second half 82 combine to form the cavities 32, and the halves 102, 104 of each conduit 54 are each disposed in a respective half 80, 82 of the foldable gasket 24. In this way, when the halves 80, 82 of the gasket 24 of FIG. 17 are folded together about the hinge 88, the halves 102, 104 of the conduits 54 are joined together to define the complete conduit 54. As discussed above, the conduits 54 may have an interior surface (e.g., interior surface 106) with a reduced coefficient of friction relative to the optical fiber cable 12 than the inner surface of the elastomeric gasket 24. Further, in the embodiment shown in FIG. 17, the gasket 24 includes a cross member 36, and to provide a flatter fold, the additional hinges 88 may be placed between the cross member 36 and the post 38.

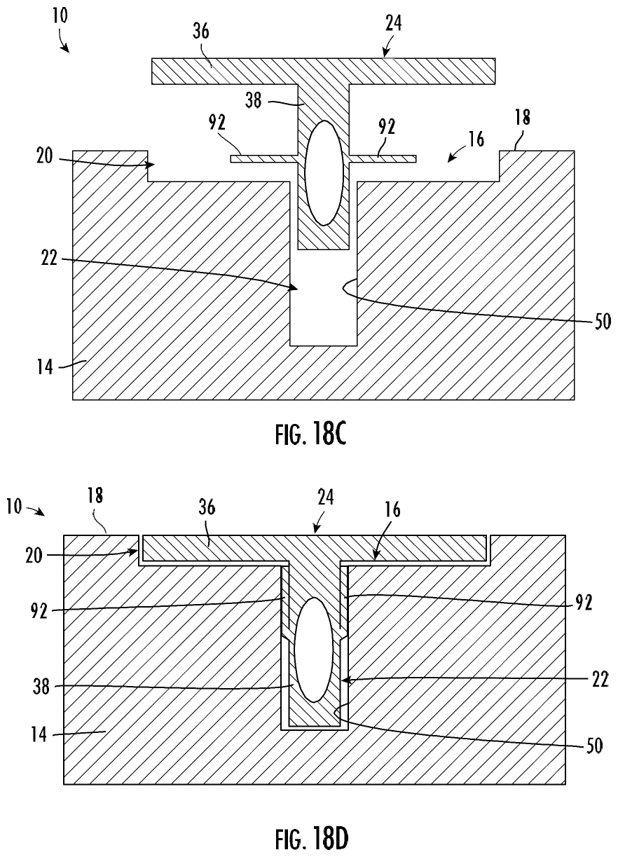

FIGS. 18A-18D depict another embodiment of a gasket 24 configured for installation in a trench 16 having either straight sidewalls 26 or angled sidewalls 26. As shown in FIG. 18A, the gasket 24 includes a cross member 36 and a post 38. A cavity 32 is formed in the post 38, and the cavity 32 can be used to carry an optical fiber cable (e.g., as shown in FIGS. 5-7) or the post 38 can be positioned over an optical fiber cable (e.g., as shown in FIGS. 1-4). Still further, while the gasket 24 is not depicted as including multiple pieces or being hinged, the gasket 24 in one or more embodiments may include multiple pieces (e.g., as shown in FIGS. 8-10) or open flat about a hinge (e.g., as shown in FIGS. 11-17).

The gasket 24 includes wings 92 extending from the sides of the post 38. In one or more embodiments, including the embodiment depicted, the wings 92 extend perpendicularly from the post 38, but in one or more other embodiments, the wings 92 may extend at an angle of 30° to 90°, in particular with the wings 92 canted upwardly toward the cross member 36.

In the embodiment of FIG. 18A, the trench 16 includes angled sidewalls 26 in the first region 20. As the gasket 24 is inserted into the trench 16 as shown in FIG. 18B, the wings 92 of the post 38 engage the sidewalls 26 of the first region and/or the third sidewalls 50 of the second region 22 and elastically fold upwardly as the post 38 is forced downwardly into the trench. This folding provides a tight frictional engagement between the wings 92 and the trench 16, and further, adhesive can be applied to the underside of the wings 92 to adhere the wings to the sidewalls 26 and/or third sidewalls 50.

In another embodiment, as shown in FIG. 18C, the same style of gasket 24 can be used-with a T-shaped trench 16 having straight third sidewalls 50. In particular, the T-shaped trench 16 includes a first region 20 in which the cross member 36 is disposed and a second region 22 in which the post 38 is disposed. As shown in FIG. 18D, inserting the post 38 into the second region 22 causes the wings 92 to fold upwardly to engage the third sidewalls 50. As shown, the wings 92 may fold until the wings 92 touch the sides of the post 38.

Thus, the embodiment of the gasket 24 of FIGS. 18A-18D provides a single gasket structure that can be used with a multitude of trench configurations.

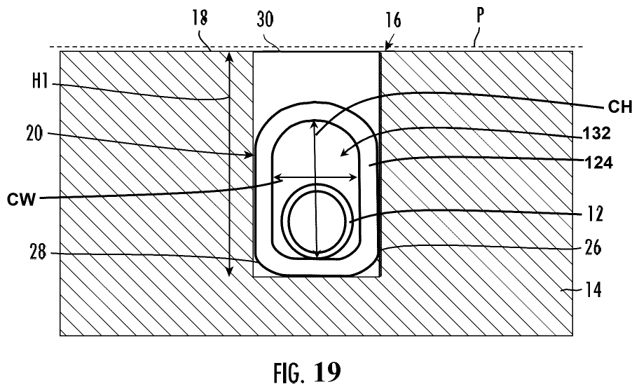

FIG. 19 depicts an embodiment of a flexible tube 124 in a trench 16 in which the optical fiber cable 12 is positioned within a cavity 132 of the tube 124. As discussed with reference to FIG. 5, the trench 16 for installation of the flexible tube 124 may not be stepped and has just the first region 20 with one floor 28 and two sidewalls 26. Accordingly, the trench 16 is substantially rectangular. The tube 124 may be substantially circular until pressed into the trench 16 at which point the tube 124 is compressed by the sidewalls 26 to take on an ovular shape. The tube 124 may be comprised of an elastomer selected from the group consisting of polyurethane, silicone, a synthetic rubber, and combinations thereof. Examples of synthetic rubbers suitable for use according to embodiments of the present disclosure include neoprene, nitrile, butyl, ethylene propylene diene monomer (EPDM), and blends thereof.

As shown in FIG. 19, the height of the tube 124 is equal to or less than the first height H1 of the sidewalls 26. In this way, the tube 124 is even with or below the plane P defined by the top surface 18 of the pavement 14.

The optical fiber cable 12 may be installed into the tube 124 at the factory and provided as a combined unit for deployment into the trench 16. In accordance with other aspects of the present invention, the tube 124 may be first installed into the trench 16 and then the optical fiber cable 12 can be pulled or blown into the tube 124. In accordance with yet other aspects of the present invention, the optical fiber cable 12 may be pulled or blown into the tube 124 prior to the combined unit being installed into the trench 16.

Alternatively, in one or more embodiments, a conduit (not shown) can be inserted into the cavity 132 of the tube 124, and then the tube 124 containing the conduit is pressed into the trench 16. In this way, an optical fiber cable 12 can be jetted, blown, or pulled through the conduit to position the optical fiber cable 12 within the tube 124 in the trench 16.

To provide sufficient space for the optical fiber cable 12 to bend sinusoidally along its length, the cavity 132 in one or more embodiments is an elongated shape, such as a racetrack, rectangle, oval, or ellipse. In particular, the cavity 132 has a cavity height CH that is greater in dimension than a cavity width CW. In accordance with aspects of the present disclosure, the cavity height CH may be at least twice as high as an outer diameter of the optical fiber cable 12 to provide room for movement of the optical fiber cable 12 within the cavity 132 and/or room for movement of the optical fiber cable 12 if the floor of the trench 16 buckles or moves in a way that forces the tube 124 to deform upward toward the surface of the trench 16. A sealant may be used to fill in the space above the tube 124 in the trench 16 and to further lock the tube 124 in place. As described above with respect to various gasket embodiments, adhesives and/or primers may be used to coat the tube 124 and/or the walls or floor of the trench to provide additional bonding and/or friction during installation to hold the tube 124 in place in the trench 16.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An installation, comprising
pavement having a top surface;
a trench formed in the pavement, the trench comprising a first region having a first width and a second region having a second width that is less than the first width, and the first region being closer to the top surface than the second region;
an optical fiber cable disposed in the second region of the trench;
a gasket disposed in the first region of the trench and covering the optical fiber cable;
wherein the first region of the trench has first sidewalls and a first floor; and
wherein the gasket is disposed between the first sidewalls and abutted against the first floor.

2. The installation of claim 1, wherein the gasket comprises an internal cavity extending longitudinal along a length of the gasket.

3. The installation of claim 1, wherein the trench further comprises a third region having second sidewalls and a second floor, wherein the first region is disposed between the third region and the second region, wherein the gasket comprises a cross member and a post extending from the cross member, wherein the cross member is disposed between the second sidewalls and abuts the second floor, and wherein the post is disposed in the first region.

4. The installation of claim 3, wherein the first sidewalls are angled and wherein the post comprises angled surfaces that engage the first sidewalls.

5. The installation of claim 4, further comprising a second post extending from the post into the second region, wherein a plurality of ribs extend from the second post to engage third sidewalls of the second region.

6. The installation of claim 1, wherein the optical fiber cable comprises a diameter, wherein a spacing is provided between a bottom of the gasket and the optical fiber cable in the second region, and wherein the spacing is in a range of greater than or equal to half the diameter to less than or equal to twice the diameter.

7. A gasket for carrying at least one optical fiber cable within a trench, the gasket comprising:
an elongated elastomeric body having a longitudinal axis along a length thereof;
at least one cavity formed in the elastomeric body and extending longitudinally along the length of the elastomeric body;
wherein each of the at least one cavity comprises a first dimension perpendicular to the longitudinal axis and a second dimension perpendicular to the longitudinal axis and to the first dimension;
wherein the first dimension is greater than the second dimension.

8. The gasket of claim 7, further comprising a conduit disposed in the at least one cavity.

9. The gasket of claim 7, further comprising an optical fiber cable disposed in the at least one cavity, wherein the optical fiber cable comprises an optical connector at at least one end thereof.

10. The gasket of claim 7, wherein the elastomeric body defines a cross member and a post that extends from the cross member and wherein each of the at least one cavity is disposed in the post.

11. The gasket of claim 10, further comprising a plurality of ribs extending from each side of the post.

12. The gasket of claim 10, wherein the post comprises at least two cavities.

13. The gasket of claim 7, wherein the elastomeric body comprises a first piece and a second piece, wherein the first piece comprises at least one first channel and the second piece comprises at least one second channel, and wherein, when the first piece and the second piece are joined, the at least one first channel and the at least one second channel form the at least one cavity.

14. The gasket of claim 13, wherein the first piece comprises a first inward surface, wherein the second piece comprises a second inward surface, and wherein the first inward surface mates to the second inward surface.

15. The gasket of claim 13, wherein the at least one first channel comprises a plurality of first channels, wherein the at least one second channel comprises a plurality of second channels, wherein the at least one cavity comprises a plurality of cavities, and wherein, when the first piece and the second piece are joined, the plurality of first channels and the plurality of second channels collectively form the plurality of cavities.

16. The gasket of claim 13, wherein the first piece comprises a first outer surface, wherein the second piece comprises a second outer surface, and wherein respective pluralities of grooves are formed in each of the first outer surface and in the second outer surface.

17. The gasket of claim 7, wherein the elastomeric body comprises a first half and a second half, wherein the first half and the second half are split at a first end of the elastomeric body, and wherein the first half and the second half are joined by a hinge at a second end of the elastomeric body.

18. The gasket of claim 7, wherein the elastomeric body comprises a first half and a second half, wherein the first half and the second half have a thinned region disposed therebetween, and wherein the thinned region is configured to operate as a hinge about which the first half and the second half are configured to fold around an optical fiber cable.

19. The gasket of claim 18, wherein, in a folded configuration, the first half and the second half define a cross member and a post extending from the cross member.

20. The gasket of claim 19, wherein the post comprises angled surfaces configured to engage angled sidewalls of the trench.
